(19) United States
(12) Patent Application Publication
(10) Pub. No.: US 2010/0149171 A1
(43) Pub. Date: Jun. 17, 2010

(54) SOURCE DRIVER FOR DRIVING A PANEL AND RELATED METHOD FOR CONTROLLING A DISPLAY

(76) Inventors: Da-Rong Huang, Tainan County (TW); Wen-Teng Fan, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/335,542

(22) Filed: Dec. 16, 2008

(51) Int. Cl. G09G 5/00

(52) U.S. Cl. 345/214

(57) ABSTRACT

A source driver for driving a panel includes an output buffer. The output buffer includes a first amplifier, a second amplifier, and an internal switching unit. The first amplifier includes a first stage and a second stage. The second amplifier includes a first stage and a second stage. The internal switching unit selectively connects the first stages and the second stages of the first amplifier and the second amplifier. At a charge sharing stage, the internal switching unit performs charge sharing between the second stage of the first amplifier and the second stage of the second amplifier.

### BACKGROUND OF THE INVENTION

1. Field of the Invention

The present invention relates to a source driver, and more particularly, to a source driver and method for a display.

2. Description of the Prior Art

Liquid crystal display (LCD) devices are flat panel displays characterized by their thin appearance, low radiation and low power consumption. LCD devices have gradually replaced traditional cathode ray tube (CRT) displays, and have been widely applied in various electronic products such as notebook computers, personal digital assistants (PDAs), flat panel televisions, or mobile phones. An LCD device usually includes an LCD panel, a timing controller, a gate driver, and a source driver. When the LCD device operates under a frame rate higher than 60 Hz, the driving ability of its source driver to charge the capacitor of the source driver is poor.

FIG. 1 is a diagram showing a conventional display. The display includes a source driver 100, a gate driver 160, and a panel 180. The panel 180 includes scan lines SL and data lines DL, respectively driven by the gate driver 160 and the source driver 100. A frame is displayed line by line. During a line period, the gate driver 160 activates one scan line, and the source driver 100 outputs driving voltages to the data lines DL, such that the pixels corresponding to the activated scan line receive the driving voltages.

The source driver 100 includes an output buffer 130 and a switching unit 150. The output buffer 130 is an amplifying unit, having a first operational amplifier 110 and a second operational amplifier 120, wherein the first operational amplifier 110 drives the panel 180 according to a first polarity and the second operational amplifier 120 drives the panel 180 according to a second polarity opposite to the first polarity. For example, the first operational amplifier 110 corresponds to a positive polarity, and the second operational amplifier 120 corresponds to a negative polarity. The switching unit 150 is coupled between the output buffer 130 and the panel 180 for controlling whether to enable charge sharing and/or to connect the output buffer 130 to the panel 180.

FIG. 2 is a timing diagram showing the waveforms of the signals of the source driver 100 shown in FIG. 1. A symbol TP represents a transfer signal for controlling the source driver 100 to start driving the panel 180. A symbol POL represents a polarity signal of the source driver 100. For 1-line dot inversion application, the polarity signal POL changes its polarity every line period. The control signal CS is used for controlling whether to enable the charge sharing of the panel 180. Symbols V_{M1} and V_{M2} represent voltage levels of internal nodes M1 and M2 of the first operational amplifier 110 and the second operational amplifier 120, respectively.

A line period begins by the asserted transfer pulse TP. During the first line period, a charge sharing stage is first performed by turning on the switch SW8 controlled by the control signal CS. After the charge sharing stage ends, a driving stage begins by unasserting the control signal CS. Thus the source driver 100 is electrically connected to the data lines DL via the switching unit 150, and starts to drive the panel 180 based on the input voltages, V_{IN1} and V_{IN2}. The first operational amplifier 110 outputs a driving voltage of the positive polarity and the display uses 1-line dot inversion, thus the voltage level V_{M1} is first decreased (from V₁₁ to V₁₂ for example) according to the input voltage V_{IN1} so as to charge the pixel of the corresponding data line and then gradually increased until the pixel is charged to the target voltage. The second operational amplifier 120 outputs a driving voltage of the negative polarity, and thus the voltage level V_{M2} is first increased according to the input voltage Vin2 so as to charge the pixel of the corresponding data line and then gradually decreased until the pixel is charge to the target voltage.

As mentioned above, the source driver 100 uses the period T₁ to drive the panel 180 at the first line period. The period T₁ gets longer as the slew-rate of the source driver 100 gets smaller. If the LCD device operates under a frame rate higher than 60 Hz, the driving ability of the source driver 100 to charge the panel 180 is poor. Hence, improving the driving ability of the source driver and reducing power consumption have become considerations for the future.

### SUMMARY OF THE INVENTION

It is one of the objectives of the claimed invention to provide a source driver for driving a panel and a related method to solve the abovementioned problems.

According to one embodiment, a source driver for driving a panel is provided. The source driver includes an output buffer, the output buffer includes a first amplifier, a second amplifier, and an internal switching unit. The first amplifier has a first stage and a second stage. The second amplifier has a first stage and a second stage. The internal switching unit connects the first stages and the second stages of the first amplifier and the second amplifier. At a charge sharing stage, the internal switching unit performs charge sharing between the second stage of the first amplifier and the second stage of the second amplifier. The internal switching unit includes a first switch, a second switch, and a third switch. The first switch is coupled between the first stage and the second stage of the first amplifier. The second switch is coupled between the first stage and the second stage of the second amplifier. The third switch is coupled between the second stage of the first amplifier and the second stage of the second amplifier. At the charge sharing stage, the third switch is turned on, and the first switch and the second switch are turned off when the third switch is turned on.

According to one embodiment, a method for controlling a display is provided. The display includes a source driver and a panel. The source driver includes an output buffer, and the buffer includes a first amplifier having a first stage and a second stage, a second amplifier having a first stage and a second stage, and an internal switching unit. The method includes the steps of performing charge sharing between the second stage of the first amplifier and the second stage of the second amplifier via the internal switching unit during a charge sharing stage of a first line period; and connecting the first stage to the second stage of the first amplifier, and connecting the first stage to the second stage of the second amplifier via the internal switching unit during a driving stage of the first line period.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a conventional display according to the prior art.

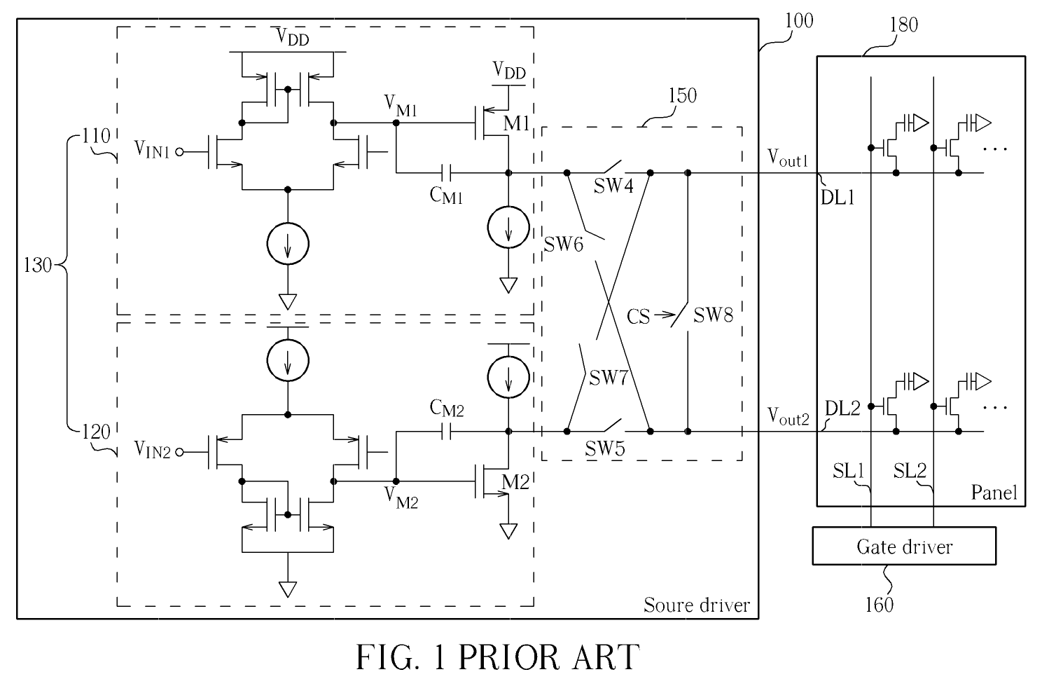

FIG. 2 is a diagram showing the waveforms of the signals of the source driver shown in FIG. 1.

FIG. 3 is a diagram showing a source driver of a display according to an embodiment of the present invention.

FIG. 4 is a diagram showing the waveforms of the signals of the source driver in FIG. 3 according to a first embodiment of the present invention.

FIG. 5 is a diagram showing the waveforms of the signals of the source driver in FIG. 3 according to a second embodiment of the present invention.

FIG. 6 is a flowchart illustrating a method for controlling a display according to an exemplary embodiment of the present invention.

### DETAILED DESCRIPTION

Certain terms are used throughout the following description and claims to refer to particular components. As one skilled in the art will appreciate, hardware manufacturers may refer to a component by different names. This document does not intend to distinguish between components that differ in name but in function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

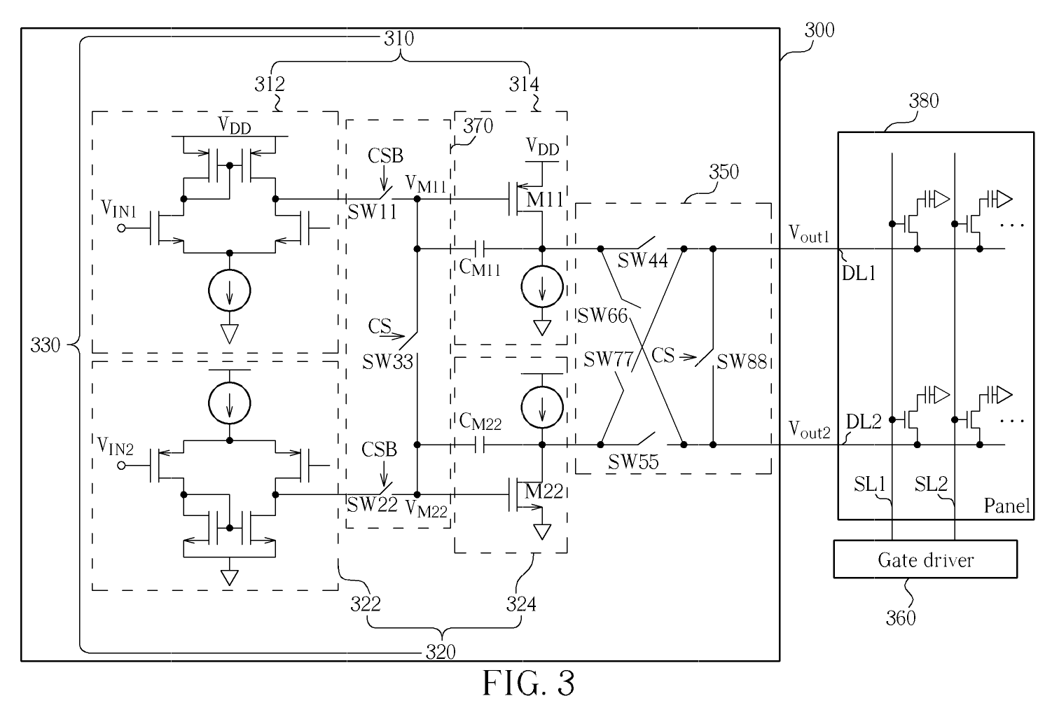

FIG. 3 is a diagram showing a display according to an embodiment of the present invention. The display includes a source driver 300, a gate driver 360 and a panel 380. The panel 380 includes scan lines SL and data lines DL, respectively driven by the gate driver 360 and the source driver 300. The source driver 300 includes an output buffer 330 and an output switching unit 350. The output buffer 330 includes a first amplifier 310, a second amplifier 320, and an internal switching unit 370. The first amplifier 310 outputs driving voltages of a first polarity, and the second amplifier 320 outputs driving voltages of a second polarity opposite to the first polarity. For example, the first amplifier 310 outputs driving voltages of a positive polarity, and the second amplifier 320 outputs driving voltages of a negative polarity.

The first amplifier 310 has a first stage 312 and a second stage 314 selectively connected by the internal switching unit 320, wherein the second stage has a first capacitive component C_{M11}. The second amplifier 320 has a first stage 322 and a second stage 324, selectively connected by the internal switching unit 320, wherein the second stage 324 has a second capacitive component C_{M22}. The first capacitive component C_{M11} is selectively connected to the second capacitive component C_{M22} by the internal switching unit 320 during charge sharing stage of a line period. The internal switching unit 370 includes a first switch SW11, a second switch SW22, and a third switch SW33. The first switch SW11 is coupled between the first stage 312 and the second stage 314 of the first amplifier 310. The second switch SW22 is coupled between the first stage 322 and the second stage 324 of the second amplifier 320. The third switch SW33 is coupled between the second stage 314 of the first amplifier 310 and the second stage 324 of the second amplifier 320. The output switching unit 350 is coupled to the panel 380 for controlling whether to perform the charge sharing on the panel 380, and for controlling the connection of the source driver 300 to the panel 380. The connection manner of the five switches SW44-SW88 inside the output switching unit 350 is shown in FIG. 3 for example, and further description is omitted here for brevity.

During a line period, a charge sharing stage is first performed by turning on a switch SW88 of the output switching unit 350. At this time, all the other switches of the output switching unit 350, including SW44-SW77, are turned off. In addition, at the charge sharing stage, the internal switching unit 370 performs the charge sharing on the first capacitive component C_{M11} and the second capacitive component C_{M22} by turning on the switch S33 according to the control signal CS, and the switches SW11 and SW22 are turned off by an inverted control signal CSB of the control signal CS. During the driving stage, after the charge sharing stage, the output switching unit 350 turns off the switch SW88 to stop the charge sharing of the panel 180, and connects the first amplifier 310 and the second amplifier 320 to the data lines DL of the panel 380. In addition, the internal switching unit 370 turns off the switch SW33, and turns on the first switch SW11 and the second switch SW22. In other words, during the charge sharing stage, both the panel 308 and the output buffer 330 perform the charge sharing.

Please note that each of the abovementioned switches SW11-SW88 can be implemented by a metal oxide semiconductor filed transistor (MOSFET), but can also be other types of switches. In addition, the output switching unit 350 can be disposed outside the source driver or on the panel.

The embodiment above is presented merely for describing features of the present invention, and should not be considered to be limitations of the scope of the present invention. Certainly, people skilled in the art will readily appreciate that other designs of implementing the amplifiers 310 and 320 are feasible.

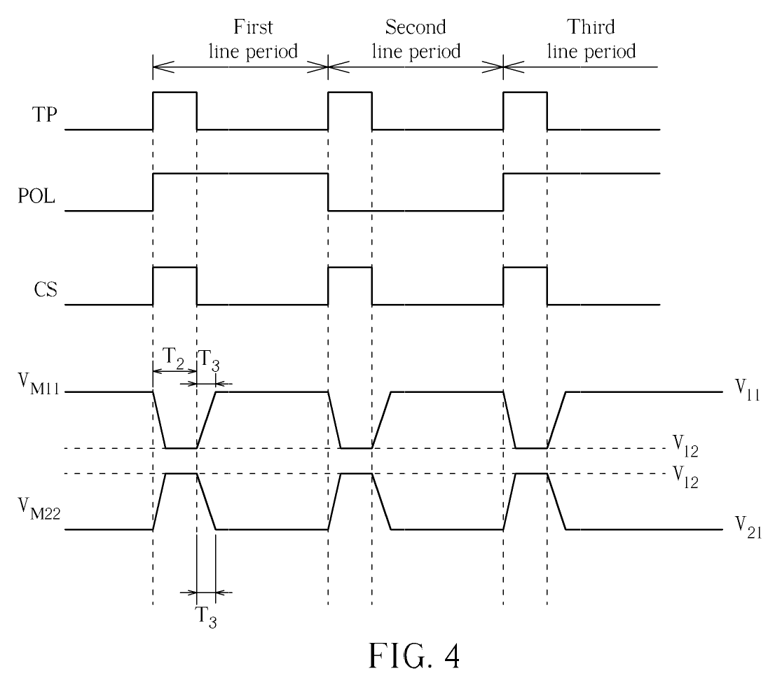

FIG. 4 is a diagram showing the waveforms of the signals of the source driver 300 in FIG. 3 according to a first embodiment of the present invention. In this embodiment, the source driver 300 is used in 1-line dot inversion application. The first line period begins based on the asserted the transfer signal TP. Initially during the first line period, a charge sharing stage is performed, indicated by the control signal CS, such that the panel 380 and the output buffer 330 of the source driver 300 respectively perform charging sharing. During the charge sharing stage, source driver 300 is set to a high-impedance state, that is, the source driver 300 is disconnected from the panel 380. Symbols V_{M11} and V_{M22} respectively represent voltage levels of the internal nodes M11 and M22 of the first operational amplifier 310 and the second operational amplifier 320. During the charge sharing stage, the output buffer 330 performs charge sharing between the first capacitive component CM11 and the second capacitive component CM22 by turning on the switch SW33, such that the voltage level of the VM11 is pulled low and the voltage level of VM22 is pulled high until these two voltage levels are equal. During the driving stage, after the charge sharing stage, the source driver 300 is connected to the data lines DL of the panel 380 via the output switching unit 350, and starts to output the driving voltages to the data lines DL. Since the voltage level V_{M11} has already been pulled low during the previous charge sharing stage, the transistor M11 of the second stage 314 has larger charge current to charge the pixel of the corresponding data line, thus the slew rate of the first operational amplifier 310 is enhanced. Similarly, since the voltage level V_{M22} has already been pulled high during the previous charge sharing stage, the transistor M22 of the second stage 324 has larger discharge current to discharge the pixel of the corresponding data line, thus the slew rate of the second operational amplifier 320 is enhanced.

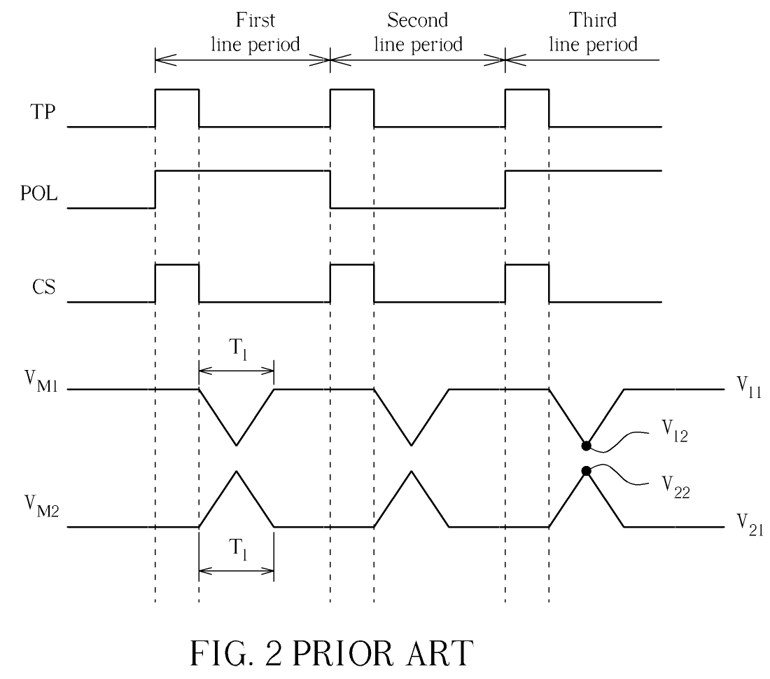

As shown in FIG. 4, because the charge sharing of the first capacitive component C_{M11} and the second capacitive component C_{M22} is performed during the charge sharing stage, the period T₂. After that, the source driver 300 spends a period T₃, being smaller than the period T₁ shown in FIG. 2, on driving the panel 380. Therefore, the slew rate of the source driver 300 can be improved.

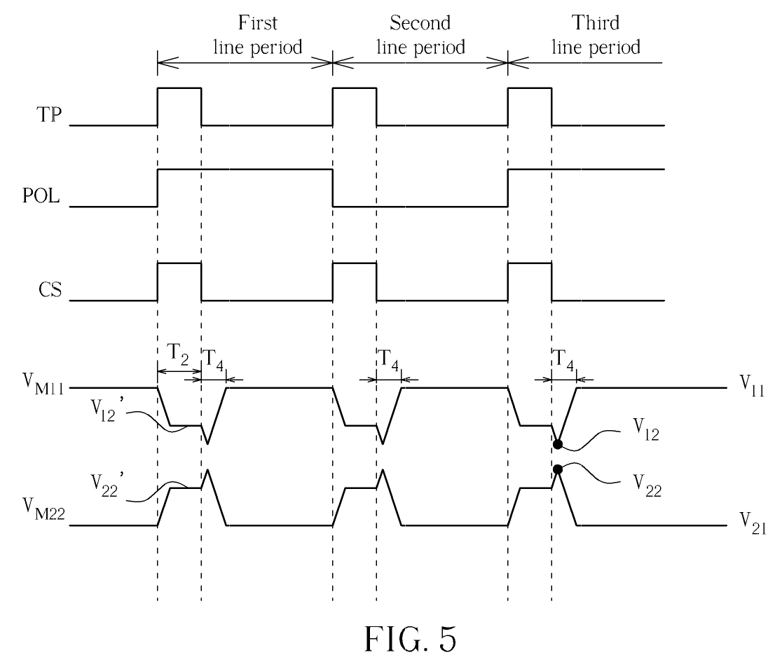

FIG. 5 is a diagram showing the waveforms of the signals of the source driver 300 in FIG. 3 according to a second embodiment of the present invention. The waveforms in FIG. 5 are similar to those in FIG. 4, and the difference between them is described as below. During the charge sharing stage, the voltage V_{M11} is decreased from V₁₁ to V₁₂′, and the voltage V_{M22} is increased from V₂₁ to V_{21′}, equal to V_{12′}. After the charge sharing stage, the voltage V_{M11} may be further decreased and then increased until the pixel is charged to a target level, and the voltage V_{M22} may be further increased and then decreased until the pixel is discharged to a target level. A period T₄ for driving the panel 380 is still smaller than the period T₁ shown in FIG. 2.

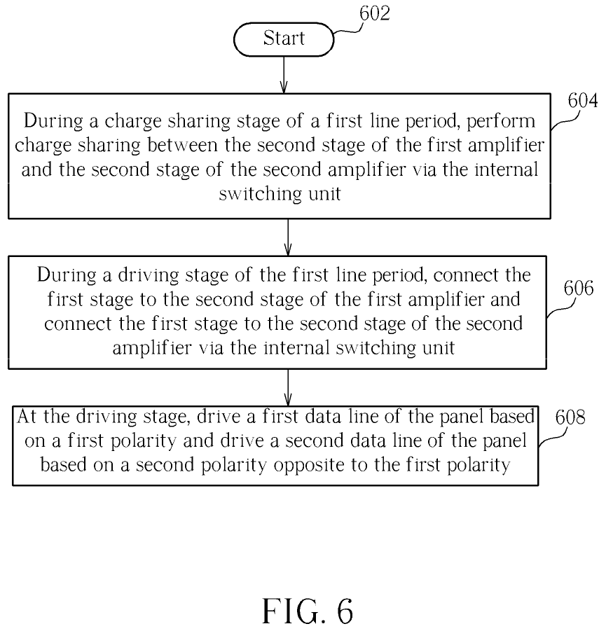

Please refer to FIG. 6. FIG. 6 is a flowchart illustrating a method for controlling a source driver of a display according to an embodiment of the present invention. Please note that the following steps are not limited to be performed according to the exact sequence shown in FIG. 6 if a roughly identical result can be obtained. The method includes the following steps:

Step 602: Start.

Step 604: During a charge sharing stage of a first line period, perform charge sharing between the second stage of the first amplifier and the second stage of the second amplifier via the internal switching unit.

Step 606: During a driving stage of the first line period, connect the first stage to the second stage of the first amplifier and connect the first stage to the second stage of the second amplifier via the internal switching unit.

Step 606: At the driving stage, drive a first data line of the panel based on a first polarity and drive a second data line of the panel based on a second polarity opposite to the first polarity.

How each element operates can be known by collocating the steps shown in FIG. 6 and the elements shown in FIG. 3. The descriptions of the steps shown in FIG. 6 have already been detailed in the embodiments above, and further description is omitted here for brevity.

Note that the method shown in FIG. 6 is just a practicable embodiment, rather than limiting conditions of the present invention. Furthermore, the order of the steps merely represents a preferred embodiment of the method of the present invention. In other words, the illustrated order of steps can be changed based on the conditions, and is not limited to the above-mentioned order.

The abovementioned embodiments are presented merely for describing features of the present invention, and in no way should be considered to be limitations of the scope of the present invention. In summary, the present invention provides a source driver 300 and related method. Through enabling the charge sharing on adjacent operational amplifiers inside the operational amplifier when enabling the charge sharing on the panel, a goal of improving the slew-rate of the source driver can be achieved. Moreover, the source driver 300 disclosed in the present invention can be used in 1-line dot inversion or 2-line dot inversion applications of an LCD panel. Therefore, situations where there is poor driving ability of charging the capacitor of the LCD panel can be avoided even if the LCD panel operates under a higher frame rate.

Those skilled in the art will readily observe that numerous modifications and alterations of the device and method may be made while retaining the teachings of the invention.

What is claimed is:

1. A source driver for driving a panel, comprising:
an output buffer, comprising:
a first amplifier, having a first stage and a second stage;
a second amplifier, having a first stage and a second stage; and
an internal switching unit, for selectively connecting the first stages and the second stages of the first amplifier and the second amplifier;
wherein at a charge sharing stage, the internal switching unit performs charge sharing between the second stage of the first amplifier and the second stage of the second amplifier.

2. The source driver of claim 1, wherein the internal switching unit connects the first stage of the first amplifier to the second stage of the first amplifier, and connects the first stage of the second amplifier to the second stage of the second amplifier at a driving stage.

3. The source driver of claim 1, wherein the internal switching unit comprises:
a first switch, coupled between the first stage and the second stage of the first amplifier;
a second switch, coupled between the first stage and the second stage of the second amplifier; and
a third switch, coupled between the second stage of the first amplifier and the second stage of the second amplifier, wherein at the charge sharing stage, the third switch is turned on, and the first switch and the second switch are turned off.

4. The source driver of claim 3, wherein at a driving stage, the third switch is turned off, and the first switch and the second switch are turned on.

5. The source driver of claim 1, wherein the second stage of the first amplifier comprises a first capacitive component, and the second stage of the second amplifier comprises a second capacitive component; and charges among the first capacitive component and the second capacitive component are shared via the internal switching unit at the charge sharing stage.

6. The source driver of claim 1, wherein at the driving stage, the first amplifier drives a first data line of the panel based on a first polarity, and the second amplifier drives a second data line of the panel based on a second polarity opposite to the first polarity.

7. The source driver of claim 1, further comprising an output switching unit, for selectively connecting the output buffer to the panel, and for performing charge sharing on the panel at the charge sharing stage.

8. The source driver of claim 7, wherein at a driving stage, the output switching unit connects the first amplifier to a first data line of the panel, and connects the second amplifier to a second data line of the panel.

9. The source driver of claim 8, wherein at the charge sharing stage, the first data line and the second data line are connected via the output switching unit.

10. A method for controlling a display, the display comprising a source driver and a panel, the source driver comprising an output buffer, the output buffer comprising a first amplifier having a first stage and a second stage, a second amplifier having a first stage and a second stage, and an internal switching unit, the method comprising:
during a charge sharing stage of a first line period, performing charge sharing between the second stage of the first amplifier and the second stage of the second amplifier via the internal switching unit; and
during a driving stage of the first line period, connecting the first stage to the second stage of the first amplifier, and connecting the first stage to the second stage of the second amplifier via the internal switching unit, so as to drive the panel.

11. The method of claim 10, wherein the second stage of the first amplifier comprises a first capacitive component, and the second stage of the second amplifier comprises a second capacitive component; and charges among the first capacitive component and the second capacitive component are shared via the internal switching unit at the charge sharing stage.

12. The method of claim 10, further comprising:
at the driving stage, driving a first data line of the panel based on a first polarity; and
at the driving stage, driving a second data line of the panel based on a second polarity opposite to the first polarity.
